(19) United States
(12) Patent Application Publication
(10) Pub. No.: US 2025/0189223 A1
(43) Pub. Date: Jun. 12, 2025

(54) AUTOMATED DEVICE AND METHOD FOR DRYING MICROSCOPE SLIDES

(71) Applicant: AXATA NEOSCIENCE PRIVATE LIMITED, Pune (IN)

(72) Inventors: Akshata Jagtap, Pune (IN); Umesh Jagtap, Pune (IN)

(73) Assignee: AXATA NEOSCIENCE PRIVATE LIMITED, Pune (IN)

(21) Appl. No.: 18/843,182

(22) PCT Filed: Feb. 13, 2023
(86) PCT No.: PCT/IN2023/050147

§ 371 Date: Aug. 30, 2024

(30) Foreign Application Priority Data
Mar. 2, 2022 (IN) 202221011278

(51) Int. Cl. F26B 9/06; F26B 3/04; F26B 21/00; F26B 21/08; F26B 21/10; F26B 21/12; G01N 1/30

(52) U.S. Cl. CPC F26B 9/066; F26B 3/04; F26B 21/003; F26B 21/08; F26B 21/10; F26B 21/12; G01N 1/30

(57) ABSTRACT

An automated device heats and/or dries the microscopes slides carrying specimens, in a controlled environment defined by user to achieve consistent and reliable results. The device heats and/or dries the plurality of microscope slides, on a stationary drying platform, while positioned in a horizontal orientation. The device utilizes the fluid flow at user-defined temperature and flow rate, to achieve a uniform, efficient and controllable results, irrespective of the material composition of the microscope slides, the specimen on the slide, and the components of the device.

### FIELD OF INVENTION

The present invention relates to an “automated device and method for drying microscope slide” and more particularly a user-controlled device for heating and/or drying plurality microscope slides independent of the external and internal factors that can influence the process and result thereof.

### BACKGROUND

A variety of laboratory processes require drying of microscope slides carrying the object of analysis on one of its surfaces.

Conventionally, the microscope slides are air dried at room temperature by placing them in a horizontal orientation on a rack. While this method is useful for a few slides, the time required for drying the slides up to the required dryness may take more than 2 hours. Further, where heating of microscope slides is required, this method is found to be inconvenient.

A few examples that overcome certain disadvantages of conventional microscope slide drying are known. For example, U.S. Pat. No. 5,766,549 demonstrates convective heating to dry the microscope slides carrying the sample, while the microscope slides are horizontally placed on the belt transport, which moves the slides in succession through the drying apparatus [1]. Though this process gives a dried microscope slide within a short time at predetermined conditions of temperature and air flow rate, the apparatus dries only a single microscope slide in one cycle, which makes it time and space consuming when plurality of microscope slides are required to be dried.

U.S. Pat. No. 6,133,548 demonstrates a conductive heating plate to heat the surface of microscope slide [2]. The apparatus employs a single heating plate for one rack and thus multiple heating plates are employed making the apparatus bulky. Moreover, the heating compartments are partially enclosed, thus raising the possibility of contamination through surrounding particulate matter.

U.S. Pat. No. 10,520,403B2, US2018/0348100A1 and US2020/0088614A1 demonstrates conductive heating that is physically engaged with one surface of the microscope slide, while the slide is oriented in near vertical position [3, 4, 5]. Whereas US2016/0282375A1 and US2020/0348321A1 demonstrates a convective heated air flow along the longitude of the microscope slides [6, 7]. The microscope slides are placed on a carrier, which is oriented in near vertical orientation during the process of drying the microscope slides. Additionally, the apparatus involves movement of the carrier while the sample on the microscope slide is still in wet condition.

In above existing apparatuses, the near vertical or vertical orientation of microscope slides carrying a wet sample on its surface and/or the movement of the said slide during the process, increases the possibilities of sample being misplaced on the surface of the slide, falling off the slide surface, or even contaminating the neighboring slides, thus leading to requirement for repeating the process of slide preparation with a new sample.

The apparatuses engage only one surface of the microscope slide and direct contact of the surface of the microscope slide with the rack may leave abrasion on the contacted surface of the microscope slide and may cause contamination of the microscope slide. Such abraded or contaminated microscope slide, which will be studied under microscope, will therefore impede the thorough analysis of the sample, may also lead to incorrect analysis of the sample to be studied.

Furthermore, existing apparatuses do not provide for air flow and temperature control which are crucial when drying microscope slides carrying a variety of samples/objects for analysis, so as not to distort their structure, for accurate analysis of the same. Temperature control also plays a vital role as microscope slides made of variety of material may not withstand a predetermined temperature and may crack or even break as a result of overheating. A compact, portable device becomes a necessity when plurality of microscope slides are to be simultaneously dried in a short period of time which is not addressed by existing apparatuses. Protection from contamination through external environment must be addressed when microscopic objects are dealt with, so as not to adversely affect the analysis of the object.

### OBJECTIVE OF INVENTION

The invention presented here is successfully designed so as to solve the existing problems and provide the optimum solution to drying a plurality of microscope slides.

The principal object of the invention is to provide a flexible, controllable, reliable, and consistent apparatus for simultaneous drying of plurality of microscope slides regardless of the material composition of the microscope slides and the variety of objects mounted on them for analysis.

It is the purpose of this invention to provide a compact and portable apparatus for drying of plurality of microscope slides carrying variety of specimens in any environmental condition.

It is the purpose of this invention to minimize the direct contact of the said microscope slides with the drying apparatus such that it does not abrade the contact surface of the microscope slides.

It is the purpose of this invention to provide a stationary drying platform that allows for horizontal orientation of microscope slides carrying specimens to eliminate the movement of microscope slides carrying specimens and thus, eliminating the possibility of specimen getting misplaced on the surface of the slide, falling off the slide, or contaminating other neighboring microscope slides carrying specimens.

It is the purpose of this invention to provide a drying apparatus that enables engagement of complete microscope slide with the drying agent.

It is the purpose of this invention to provide vents to allow for fresh fluid flow through the system, thereby removing the moisture arising from the evaporation of liquid from wet specimens and accelerating the process of drying the microscope slides.

It is the purpose of the invention to provide for filters on vents for flow of clean fluid into the system, to eliminate any possibility of contamination of slides due to external factors.

It is the purpose of this invention to provide for a controller connected to various sensors and components in the system such that the user can define the parameters including, without limitation, temperature, fluid flow rate, time, etc. of the process according to their requirement.

It is the purpose of this invention to provide for a slide drying apparatus that gives high throughput in the same time period as a single slide.

### SUMMARY OF INVENTION

At least in some embodiments of the invention, an apparatus for controlled drying plurality of microscope slides is provided comprising an enclosure that houses the components of the apparatus and provides a compact body for the device, making it portable and creates an envelope for the fluid flow required to dry the microscope slides and a portal for admission and removal of slide racks carrying the microscope slides for drying. The enclosure provides a controlled environment for drying of microscope slides. In certain embodiments, the enclosure is insulated from outer surrounding environment to prevent any heat exchange with surroundings that may interfere with the required process.

In some embodiments, the apparatus is provided with a slide drying platform which can carry plurality of slide racks which are designed to hold the plurality of microscope slides in horizontal orientation with respect to the slide rack as well as enabling minimum contact with microscope slides. Wherein this configuration eliminates the abrasion on the surface of microscope slide and thus enables for accurate analysis of specimen on the microscope slide, it also provides for engaging both the surfaces of the microscope slide with the flowing fluid for uniform drying of the microscope slide.

In some embodiments of the apparatus, the slide drying platform is stationary and holds the slide rack and microscope slides in stationary position throughout the operation period. Therefore, eliminating the possibility of specimen getting misplaced on the surface of the slide, falling off the slide, or contaminating other neighboring microscope slides carrying specimens. The slide rack and slide drying platform are configured in the manner such that they enable to dry plurality of microscope slides carrying plurality of specimens simultaneously within same period of time.

The apparatus in some embodiments, comprises a fan to generate fluid flow at the required flow rate and a heating element to enable to provide required temperature to fluid flow in co-ordination with the controller input and a partition that enables diffusion of fluid flow to achieve uniform fluid flow over all the slide racks within the system.

The apparatus in some embodiments, comprises an inlet vent for inflow of filtered air and an outlet vent for outflow of filtered air, with an arrangement for filter that will enable clean fluid to enter the system and protect the specimens and microscope slides from any contamination that may obstruct correct analysis of the specimen. Further, the vents allow for fresh fluid flow, thereby removing the moisture, resulting from evaporation of liquid content of the wet specimens on the microscope slides, from the enclosure, which substantially reduces the time required to dry the microscope slides.

The apparatus in some embodiments, comprises a controller to control various parameters of the process to achieve the desired outcome at optimum efficiency and high accuracy. The controller is connected to the various sensors including, without limitation, at least a temperature sensor, a humidity sensor, a flow rate sensor, etc. and other components of the device. The controller provides for the user interface enabling the user to define the parameters including, without limitation, temperature, fluid flow rate, humidity, pressure, time, etc. to obtain optimum, reliable and accurate results for various types of microscope slides and specimens. Thus, controlled environment for drying microscope slides allows for automatically terminating the operation when the required result is achieved. Consequently, reducing the power consumption and the need for manual supervision. The controller comprises all the necessary safety features including, without limitation, auto cut-off, thermal fuse, etc. to protect the user, the device, and the environment from any injury or damage.

The apparatus in some embodiments, comprises a controller to notify and/or warn the user with a sound or light alarm about the status of the process and/or the device. The controller includes a feature to notify and/or warn the user through a communication device connected with the controller.

### BRIEF DESCRIPTION OF THE DRAWINGS

FIG. 1 is an isometric view of the automated device for slide drying in accordance with an embodiment of the present invention.

FIG. 2A is an isometric view of the slide rack in accordance with an embodiment of the present invention.

FIG. 2B is an isometric view of slide rack with microscope slides carrying specimen mounted on the rack in accordance with an embodiment of the present invention.

FIG. 3A is a top cross-sectional view of the automated device for slide drying in accordance with an embodiment of the present invention.

FIG. 3B is a side cross sectional view of the automated device for slide drying in accordance with an embodiment of the present invention.

### DETAILED DESCRIPTION OF THE INVENTION

This invention is illustrated in the accompanying drawings, throughout which, like reference numerals indicate the corresponding parts in various figures.

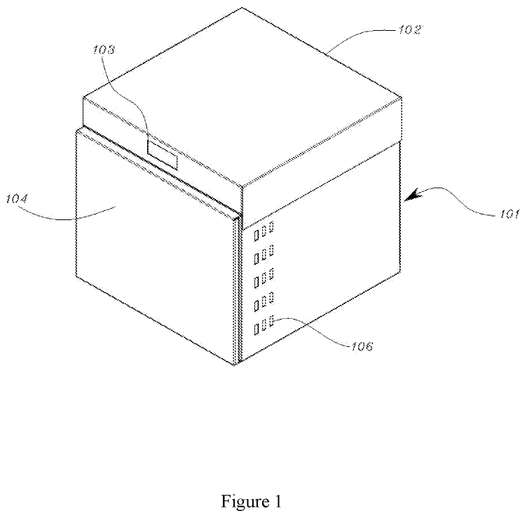

FIG. 1 is an isometric view of the automated device for slide drying (“device (101)”) in accordance with an embodiment of the present invention. The device (101) includes an enclosure (102) which houses the various components of the device (101) to provide a specified space for executing the process, without external influence. The enclosure (102), in certain embodiments, includes an insulation to eliminate the heat transfer between the enclosure (102) and the surroundings, in order to maintain the controlled internal environment of the device (101) for optimized efficiency. The enclosure (102) includes a portal (104) for access to the slide drying platform (309). The enclosure (102) includes outlet vents (106) for outward flow of the fluid. The device (101) can include a controller (103) mounted on the enclosure (102) for easy access to user.

The controller (103) can include any number of microprocessors or microcontrollers, printed circuit boards, user interfaces in any form, various sensors for detecting necessary parameters including, without limitation, temperature, humidity, fluid flow rate, timer, etc. The controller (103) can include, without limitation, certain forms of volatile and non-volatile memory which stores the various preset configuration of parameters for the user to choose from and additionally, enables the user to set the parameters, according to their preference, to allow for optimum results under varying conditions. The parameters that can be user defined can include, without limitation, temperature, humidity, fluid flow rate, time, etc. the controller (103) is connected to various components of the device (101) to provide user control over the components. The controller (103) can include a power source allowing the device (101) to be portable.

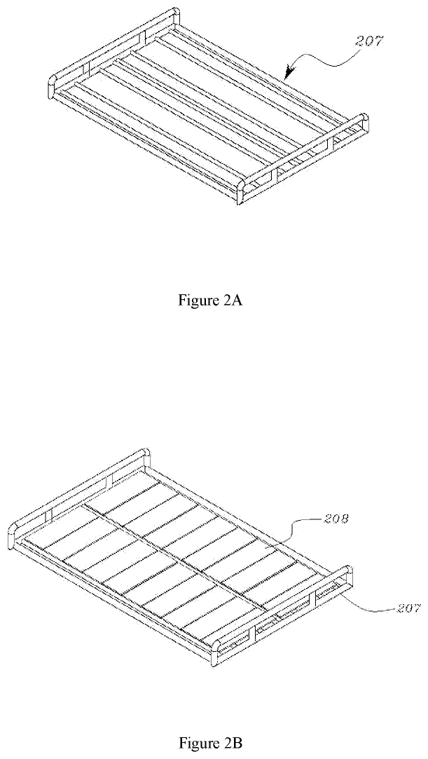

FIG. 2A is an isometric view of the slide rack (207) in accordance with an embodiment of the present invention. The slide rack (207) may accommodate any number of microscope slides for example 1 slide, 5 slides, 10 slides, etc. The slide rack (207) can include handles for accessing the slide rack (207) without contacting any surface of the microscope slide carrying the specimen (208), which eliminates any abrasion or specimen movement. In some embodiments, the slide rack (207) can include multiple rows to accommodate plurality of the microscope slides carrying the specimen (208).

FIG. 2B is an isometric view of slide rack (207) with microscope slides carrying specimen (208) mounted on the slide rack (207) in accordance with an embodiment of the present invention. The slide rack (207) herein accommodates the entire microscope slide with minimum contact between the slide rack (207) and the microscope slide carrying specimen (208), thereby protecting the microscope slide carrying specimen (208) from any contamination and abrasion. The microscope slide carrying specimen (208) are placed in horizontal orientation on the stationary slide rack (207). This configuration of horizontal placement of slides eliminates the possibilities of specimen migration over the surface as well as off the surface of the microscope slides, which eventually prevents contamination of other microscope slides carrying specimens (208) in the device (101) and enables accurate analysis of the specimen.

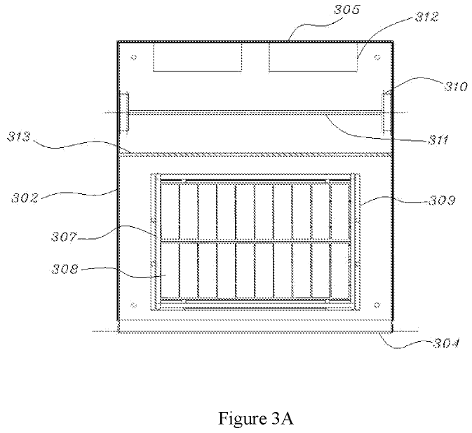

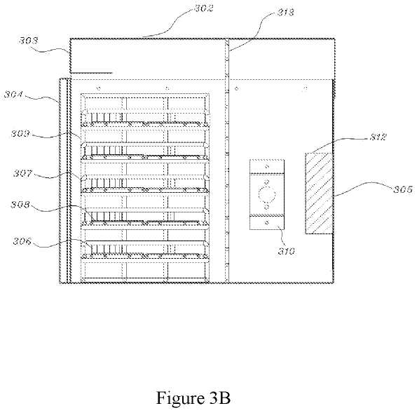

FIG. 3A is a top cross-sectional view of the automated device for slide drying in accordance with an embodiment of the present invention. The device (101) includes a slide drying platform (309), an inlet vent (305), a fan (312), a partition (313), a heating element (311), and a mounting bracket (310) for the heating element (311). The slide drying platform (309) can include of any number of shelves stacked one upon the other to accommodate any number of slide racks (207) with substantial space between them. The enclosure (302) can include inlet vents (305) that allow for flow of pure filtered fluid. The device (101) can include any number of fans (312) mounted on the enclosure (302), positioned over the vents (305). The fan (312) can include any device or component that can attain the required fluid flow and can be controlled by the user through a controller (303). The heating element (311) can include any component or device, in any configuration, that can achieve a temperature different than the ambient temperature and can be controlled by the user through a controller (303). The heating elements (311) can be mounted on the enclosure (302) with the help of mounting brackets (310). The mounting brackets (310) can be of any shape, size, configuration as suitable for mounting the heating element (311) employed. The partition (313) can include a suitable component that can divide the enclosure (302) into two chambers without blocking the passage of fluid at desired flow rate and temperature. The partition (313) allows for uniform flow of fluid over all the microscope slides, engaging both the surfaces of the microscope slides with the flowing fluid. The device (101) can include the slide drying platform and necessary sensors.

The vents (306) and (305) can include, without limitation, any fluid filter for flow of clean fluid, as a result eliminating the possibility of contamination of the specimen mounted on the microscope slides.

When in operation in this embodiment, the user can place the microscope slides carrying specimen (308) on the slide rack (307). Referring now to FIG. 3B, Subsequently, the slide racks (307) are placed on the shelves of slide drying platform (309), which can be accessed after opening the portal (304) of the enclosure (302). The user after successfully placing the slide rack (307) can then close the portal (304), and select the required configuration of parameters, such as temperature, humidity, fluid flow rate, time, etc. for drying the microscope slides through the user interface of the controller (303).

After the parameters are set by the user, the device (101) will successfully complete the process through the co-ordination of controller (303) with the sensors and other connected components. The fan (312) will start circulating fluid at the set flow rate over the heating element (311) which will be at temperature set by the user. As a result of which a heat exchange will occur between the fluid and the surface of heating element (311), and the fluid will flow at a certain temperature. This fluid will eventually flow over the microscope slides carrying specimen (308) and dry the microscope slides. The vents (306) and (305) will assist in fresh and clean fluid flow throughout the system.

TABLE 1
Experimental results for drying of the microscope
slides using the described apparatus.

| | | | | Number of | |
|---|---|---|---|---|---|
| | | | Fluid | Microscope | Time |
| | Ambient | Operating | Flow | Slides | required for |
| Sr. | Temperature | Temperature | Rate in | carrying | drying in |
| No. | (T_{A}) in ° C. | (T_{O}) in ° C. | m/s | specimen | seconds |
| 1. | 31 | 45 | 0.09 | 1 | 60 |
| 2. | 31 | 45 | 0.09 | 5 | 60 |
| 3. | 31 | 45 | 0.09 | 10 | 60 |
| 4. | 31 | 45 | 0.09 | 20 | 60 |
| 5. | 31 | 45 | 0.09 | 50 | 60 |
| 6. | 31 | 45 | 0.09 | 100 | 60 |

TABLE 2
Experimental results for drying of the microscope slides using
the described apparatus at different operating conditions.

| | | | | Number of | |
|---|---|---|---|---|---|
| | | | Fluid | Microscope | Time |
| | Ambient | Operating | Flow | Slides | required for |
| Sr. | Temperature | Temperature | Rate in | carrying | drying in |
| No. | (T_{A}) in ° C. | (T_{O}) in ° C. | m/s | specimen | seconds |
| 1. | 26 | 40 | 0.09 | 1 | 60 |
| 2. | 26 | 40 | 0.09 | 5 | 60 |
| 3. | 26 | 40 | 0.09 | 10 | 60 |
| 4. | 26 | 40 | 0.09 | 20 | 60 |
| 5. | 26 | 40 | 0.09 | 50 | 60 |
| 6. | 26 | 40 | 0.09 | 100 | 60 |

Table 1, summarizes the experimental results for drying plurality of microscope slides carrying specimens (308) using one embodiment of the device (101), wherein the embodiment can hold maximum 100 slides. It is clearly evident that the present apparatus efficiently achieves the required results in 60 seconds irrespective of the number of microscope slides, under the similar conditions of temperature and fluid flow rate. The time required for drying may vary as per user-defined temperature, fluid flow-rate, the configuration of the apparatus employed, etc. Therefore, the apparatus is highly flexible to enable the user to get the best result as per the end use.

Table 2, summarizes the experimental results for drying plurality of microscope slides carrying specimens (308) using one embodiment of the device (101), wherein the embodiment can hold maximum 100 slides. The data illustrates the consistency, reliability, flexibility and controllability of the device (101). The device (101) can dry plurality of microscope slides carrying specimens (308) simultaneously in the same time period as required for a single microscope slide under similar operating conditions. Therefore, the apparatus is highly flexible to enable the user to get the best result as per the end use.

The present invention is described in enabling detail in the following examples, which may represent more than one embodiment of the present invention. Other architectures may be possible without departing from the spirit and scope of the present invention.

In one embodiment, the user may apply forced circulation at the ambient temperature for drying the microscope slides. In that case the heating element (311) will be in standby state, and the user may set the fluid flow rate and time on the controller.

In one embodiment, the user may require the microscope slide to heat dry without forced circulation. In such case the fan (312) will be in standby state, while the heating element (311) can heat the microscope slides carrying specimen (308) through natural convection or radiation.

In one embodiment, the user may require the microscope slides to be subjected to heating for a specified period at a particular temperature. The user can then set the temperature and time as per the requirement. In that case the controller (303) will adjust the heating element (311) and stop the process after the specified time.

In one embodiment, a heating element (311) may be attached to the slide drying platform such that the microscope slides carrying specimen (308) are heated using conductive methods, without any abrasion, specimen displacement and contamination of the microscope slides carrying specimen (308).

The elements and components of the automated slide drying device can be of any size, shape, configuration, material, etc. and are within the scope of present invention disclosed herein. The temperature range will depend on the material of the enclosure, the material of the microscope slides, the specimens on the microscope slides and other components of the device, so as not to damage any part of the device. The user control over the temperature will eliminate any possibility of damage to the microscope slide and the specimen irrespective of their characteristics. The controlled fluid flow will allow the user to dry the specimen on the microscope slides without distorting the structure of the same. These features enable the user to dry plurality of microscope slides and specimens regardless of their material composition and structure, at optimum efficiency and accurately.

It will be apparent to one with skill in the art that the automated slide drying device may be provided using some or all the features and components without departing from the spirit and scope of the present invention. It will also be apparent to the skilled artisan that the embodiments described above are the specific examples of a single broader invention which may have greater scope that any singular descriptions taught. There may be many alterations made in the descriptions without departing from the spirit and scope of the present invention.

### REFERENCES

1. Gao, et. al. (1998) Apparatus for drying blood smear slides. U.S. Pat. No. 5,766,549.
2. Grover, et. al. (2000) Apparatus and method for heating microscope slides. U.S. Pat. No. 6,133,548.
3. Beer (2019) Apparatuses for heating microscope slides carrying specimens. U.S. Pat. No. 10,520,403 B2.
4. Beer (2018) Methods for heating microscope slides carrying specimens. U.S. Patent No. 2018/0348100 A1.
5. Beer (2020) Methods for heating microscope slides carrying specimens. U.S. Patent No. 2020/0088614 A1.
6. Barnett, et. al. (2016) Automated processing systems and methods of thermally processing microscope slides. U.S. Pat. No. 2016/0282375 A1.
7. Barnett, et. al. (2016) Automated processing systems and methods of thermally processing microscope slides. U.S. Pat. No. 2020/0348321 A1.

We claim:

1. An apparatus for controlled heating and/or drying plurality of microscope slides, comprising:
an enclosure (302) that houses the components of the apparatus;
a portal (304), attached to the enclosure (302), providing access to the slide drying platform (309);
a slide rack (307) to hold the plurality of microscope slides;
a slide drying platform (309) having plurality of shelves enabling to carry plurality of slide racks simultaneously;
a fan (312) mounted on the enclosure (302), to generate fluid flow at the required flow rate;
an inlet vent (305) on the enclosure (302), for inflow of fluid;
an outlet vent (306) on the enclosure (302), for outflow of fluid;
a heating element (311) within the enclosure (302), to provide the required temperature to the fluid flow;
a partition (313) within the enclosure (302), that enables diffusion of the fluid flow;
a controller (303) attached to the enclosure (302), enabling user control over various parameters of the process;

2. The apparatus of claim 1, wherein the enclosure (102) being insulated from external environment prevents heat exchange with the surroundings and enables to control the internal environment of the device (101) for heating and/or drying the plurality of microscope slides.

3. The apparatus of claim 1, wherein the slide racks (207) hold the microscope slides in horizontal orientation, with minimum surface contact between the slide rack and the microscope slides throughout the period of operation of the device (101).

4. The apparatus of claim 1, wherein the slide drying platform (309) is stationary and holds the slide rack (307) and the microscope slides in stationary position throughout the period of operation of the device (101).

5. The apparatus of claim 1, wherein the slide rack (307) and slide drying platform (309) configured to dry plurality of microscope slides carrying plurality of specimens simultaneously within the same period of time, irrespective of the number of the microscope slides engaged in one operating cycle of the device (101).

6. The apparatus of claim 1, wherein the inlet vents (305) and outlet vents (306) comprising of the filter apparatus, enable flow of clean fluid in the system and prevent the contamination of the internal environment of the device (101).

7. The apparatus of claim 1, wherein the controller (103) provides for the user interface enabling the user to define the operating parameters including, without limitation, temperature, fluid flow rate, humidity, pressure, time, etc.

8. The apparatus in claim 1, wherein the user-controlled environment of slide drying allows for automatically terminating the operation when the required result is achieved, which helps in reducing the power consumption and manual interference.

9. The apparatus of claim 1, wherein the controller (103) provides for an alert system including, without limitation, a sound alarm, messages to a communication device, etc. to notify and/or warn the user about the status of the process and/or device.

10. The method for controlled heating and/or drying plurality of microscope slides, comprising:
horizontal positioning of plurality of microscope slides on the slide rack (307), with minimum contact between the microscope slides and the slide rack (307);
placement of the slide rack (307) on the stationary slide drying platform (309), accessed through the portal (304) of the enclosure (302);
selecting the temperature, fluid flow rate, humidity, time, etc. with help of the controller (303), to obtain optimum result according to the composition of the microscope slide, specimen on the slide, and external conditions;
allowing the vents (305) of the enclosure to provide a filtered fresh and clean fluid flow into the system, resulting in reduced humidity within the system and accelerated drying and/or heating of the microscope slides;
allowing the fluid to flow, at a user-defined temperature and flow-rate, within the enclosure (302) to uniformly dry the microscope slides carrying specimens (308) by engaging both the surfaces of the slides with the flowing fluid.

11. The method of claim 10, wherein the fluid at user-defined flow rate and temperature, achieves uniform heating and/or drying of plurality of microscope slides simultaneously, without distorting the morphology of the specimen or contaminating the neighboring specimens within the system.

12. The method of claim 10, wherein the temperature range that user can define will depend on the material composition of the microscope slides, the specimens on the slides, and the components of the device (101).

13. The method of claim 10, wherein the fluid flow rate may vary according to the configuration of the device (101), the material and composition of the microscope slides, the specimens on the slides.

14. The method of claim 10, the microscope slides are dried in a controlled environment in less than 120 seconds, at lower temperatures and low fluid flow rates and gives consistent results for any number of microscope slides.
